(19) United States
(12) Patent Application Publication
(10) Pub. No.: US 2026/0149720 A1
(43) Pub. Date: May 28, 2026

(54) NEUTRAL HOST NETWORKS FOR PRIVATE CELLULAR NETWORKS

(71) Applicant: HEWLETT PACKARD ENTERPRISE DEVELOPMENT LP, Spring, TX (US)

(72) Inventor: HEMA PENTAKOTA, Spring, TX (US)

(21) Appl. No.: 19/096,122

(22) Filed: Mar. 31, 2025

Related U.S. Application Data
(60) Provisional application No. 63/724,262, filed on Nov. 22, 2024.

(51) Int. Cl. H04L 9/40; H04L 41/5003; H04W 12/06; H04W 12/086; H04W 84/04

(52) U.S. Cl. CPC H04L 63/105; H04L 41/5003; H04W 12/06; H04W 12/086; H04W 84/042

(57) ABSTRACT

Systems and methods provide for private cellular networks as Neutral Host Networks (NHN) by facilitating connections between a private cellular network and mobile network operator (MNO) core networks for authenticating user equipment (UEs) for access to the private cellular network using credentials for the MNO core networks. Examples include a connection system that receives an access request from a private cellular network that includes a UE identifier and a network identifier of an MNO, verifies that the MNO permits NHN services, and, based on the verification, establish a channel between the private cellular network and a core network corresponding to the network identifier. The connection system routes the access request message to the core network, which authenticates the UE. The UE can be granted access to the private cellular network based on the authentication from the core network.

### CROSS REFERENCE TO RELATED APPLICATIONS

This application claims the benefit of and priority to U.S. Provisional Ser. No. 63/724,262 , filed on Nov. 22, 2024, the contents of which are

incorporated herein by reference in their entirety.

### BACKGROUND

Neutral Host Networks (NHNs) are sharable wireless infrastructures that allow one or more communication service providers (CSPs) to use that infrastructure to serve their customers. Generally, NHNs are owned and operated by third parties that permit the CSP subscribers to use the NHN to expand network coverage of the CSP to the NHN.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example network installation with which the systems and methods disclosed herein might be implemented in various applications.

FIG. 2 illustrates an example communication system in which examples of the present disclosure can be implemented.

FIG. 3 illustrates an example message flow for authenticating a user equipment for access to a neutral host network on the communication system of FIG. 2, in accordance with an example disclosed herein.

FIG. 4 illustrates another example message flow for authenticating a user equipment for access to a neutral host network on the communication system of FIG. 2, in accordance with an example disclosed herein.

FIG. 5 illustrates yet another example message flow for authenticating a user equipment for access to a neutral host network on the communication system of FIG. 2, in accordance with an example disclosed herein.

FIG. 6 illustrates another example of communication system in which examples of the present disclosure can be implemented.

FIG. 7 illustrates an example message flow for authenticating a user equipment for access to a neutral host network on the communication system of FIG. 6, in accordance with an example disclosed herein.

FIG. 8 illustrates a computing component that may be used to implement neutral host networks on private cellular networks in accordance with various examples of the disclosed technology.

FIG. 9 depicts a block diagram of an example computer system in which various examples of the disclosed technology described herein may be implemented.

The figures are not exhaustive and do not limit the present disclosure to the precise form disclosed.

### DETAILED DESCRIPTION

As the demand for reliable and high-capacity mobile connectivity has surged, NHNs can be utilized to provide seamless and high-quality wireless services by expanding a CSPs network to the NHN. For example, cellular networks can suffer poor connectivity in indoor environments due to interference from surrounding structures. NHNs can be used to extend the cellular network coverage into these environments by leveraging private mobile networks offered within such indoor environments as an NHN.

As used herein, a CSP refers to an operator (or entity) that provides communication services, such as but not limited to mobile phone services, internet services, satellite communication, and cable television. A Mobile Network Operator (MNO), as used herein, refers to a category or type of CSP that provides mobile services, including infrastructure, customer service, and billing, through a cellular communications network (e.g., Verizon, AT&T, T-Mobile, etc.). MNOs own and maintain their own cellular network infrastructure, referred to as a core network (or a MNO core network). A cellular network can comprise two component networks, a radio access network (RAN) and the core network. In 5th Generation (5G) cellular networking systems these components are a 5G radio access network (5G-RAN) and a 5G core network (5GC). In 4^{th} Generation/Long Term Evolution (4G/LTE, or 4G for simplicity) cellular networking systems these components are radio access network (RAN) and an Evolved Packet Core Network (EPC).

In some cases, enterprises, such as stadiums, convention centers, and the like, may provide a NHN through a distributed antenna system (DAS). A DAS may refer to a network of spatially separated antenna nodes connected to a common source to provide wireless service within a geographic area or structure. Subscribers of MNOs may utilize a DAS to access a network operated by an MNO upon entering the geographic area or structure. However, deploying a DAS can face several challenges, including high installation costs, complex design requirements due to the structures, a need for extensive cabling, potential signal interference, managing multiple MNOs involved, and ensuring proper optimization to balance coverage and capacity within the system, all of which can significantly impact the overall project cost and success. Accordingly, DAS may not be feasible for small or medium sized enterprises.

An alternative approach to DAS is a Multi-Operator Core Network (MOCN). An MOCN can be a single RAN that is deployed in an enterprise and shared by MNOs. An MOCN includes a MOCN gateway that provides a direct connection with core networks of one or more MNOs, which the subscribers of the one or more MNOs can use to access a respective core network while present within an area covered by a private enterprise network. By providing the MOCN gateway with direct connection to MNO core networks, the MOCN deployment can bypass network functions and authentication protocols of the core network.

Deploying a MOCN, however, can face several challenges, which can hamper adoption by enterprises. For example, an enterprise may be required to ensure device compatibility, manage service level agreements (SLA) across various MNOs, guarantee quality of service (QoS) on the shared network for the various MNOs, and navigate complex interoperability testing, as well as face potential challenges with spectrum allocation, handoff management between MNO core networks, and security risks through bypassing authentication protocols. For example, if a hospital deploys an MOCN to provide a NHN to patients and employees within the hospital, the hospital may be required to establish direct connections to each MNO's cellular network through SLAs and address the above complications. Expanding this to a number of different enterprises that each establish their own direct connections and deploy respective MOCNs can result in a bottleneck for MOCN deployments. This can be because MNOs may not be interested in the deployments if their subscribers receive poor connectivity or other events that violate SLAs, particularly because the MNOs do not receive additional revenue or incentives for MOCN deployments. Additionally, establishing the direct connection can be hurdle for enterprises due to managing the direct connections with the different MNOs. As a result, adoption of MOCN has been slow.

Another approach is to extend an MNO's core network to a Wi-Fi network. Passpoint® is a solution promulgated by the Wi-Fi Alliance that can use a Wi-Fi network as an NHN. For example, when a subscriber of an MNO enters a coverage area of a particular Wi-Fi network, the subscriber can connect to the MNO's core network via the Wi-Fi network using the subscriber's MNO credentials if the MNO has enabled Passpoint® for the particular Wi-Fi network. Thus, the MNO's core network can be extended to the Wi-Fi network. However, as Passpoint® is a protocol defined by the Wi-Fi standards, Passpoint has been conventionally limited to Wi-Fi networks.

Yet, as the demand for reliable, secure, and high-capacity connectivity increases, enterprises may seek to deploy private cellular networks within a particular geographic area or structure. A private cellular network, particularly a private 5G cellular network, can offer improved coverage, higher speeds, and enhanced security compared to a Wi-Fi network due to the radio frequency (RF) spectrum dedicated to cellular network, superior mobility capabilities, and stricter access controls through Subscriber Identify Module (SIM) card authentication, These aspects may make private cellular networks attractive to enterprise applications where reliable, high-bandwidth connectivity may be crucial.

Examples of the technology disclosed herein provides for enabling private cellular networks as NHNs by facilitating connections between a private cellular network and MNO core networks for authenticating UEs for access to the private cellular network using authentication credentials for accessing the MNO core networks. Absent the examples disclosed herein, the MNO core network may be remote from (e.g., unconnected with) the private cellular network. The examples herein may leverage Passpoint techniques in conjunction with authenticating user equipment (UEs) using an external credential server (e.g., authentication, authorization, and accounting (AAA) server external to the private cellular network that a subscriber seeks to access) to provide an indirect connection between the private cellular network and MNO core networks that the private cellular network can use for authenticating unknown UEs.

For example, 3rd Generation Partnership Project (3GPP) Release 17, which is a standard promulgated by 3GPP, provides standardized protocols through which UEs be authenticated using an external credential server. Particularly, when a UE provisioned to an MNO (e.g., associated with a subscriber subscribed to the MNO) attempts to connect to a private cellular network, the examples herein may establish an authentication channel providing an indirect connection between the private cellular network and the MNO. An access request can be routed from the private cellular network to the MNO's core network through the authentication channel for verifying authentication credentials at the core network of the MNO. Once verified, the private cellular network can grant the UE access to the private cellular network using the authentication credentials for access to the MNO's core network. As a result, the private cellular network can provide a NHN that extends the MNO's core network to the coverage area of the private cellular network.

Whereas, conventionally, an enterprise that uses a private cellular network may be required to provision individual SIM cards (physical SIM cards or eSIM cards) to each UE that seeks access to the private cellular network. Along with the costs and complexity in issuing and managing numerous SIM cards, subscribers would have to toggle between the SIM cards to switch between the private cellular network and MNO core network depending on which network the UE attempts to connect too at a given instance.

In an illustrative example of the technology disclosed herein, when a UE provisioned by an MNO attempts to connect to an base station of the private cellular network, a NHN connection system (sometimes referred to herein as a connection system) can be configured facilitate connections between the private cellular network and the MNO's core network for authenticating the UE for access to the private cellular network using authentication credentials provisioned by the MNO. In this case, the NHN connection system may establish an authentication channel that can provide an indirect connection between the private cellular network and the MNO. The NHN connection system may pass authentication credentials provisioned by the MNO (e.g., credentials that can be used for authenticating access to the MNO's core network) through the private cellular to the MNO's core network. The MNO's core network can authenticate the UE using the authentication credentials and notify the private cellular network of the authentication via the NHN connection system. The private cellular network can use the authentication with the MNO's core network to grant the UE access to the private cellular network.

The NHN connection system can be configured with Passpoint techniques that can be used for authenticating UEs using authentication credentials of the MNO's core networks. For example, the NHN connection system can be configured by associating NHN indicators with network identifiers that identify a MNO's core network (referred to herein as MNO network identifiers) based on service information received from or otherwise corresponding to the MNOs. The service information, such as service definitions, may be included in SLAs that define NHN services offered by the MNOs and the NHN connection system may receive these SLAs, which can be used to create configuration files for the MNOs. The configuration files may be associated with MNO network identifiers and may include NHN indicators representing whether or not an MNO has enabled (e.g., offers) NHN services to its subscribers. If offered, the configuration may include an NHN indicator that the NHN connection system can use to verify or otherwise determine that MNOs corresponding to configuration file offer NHN services. The absence of an NHN indicator may represent that NHN services are not offered.

In an illustrative implementation, a SIM-enabled UE may initiate registration with a mobility function of a private cellular network by sending an authorization request message to the mobility function. A mobility function may refer to, for example, a private Access and Mobility Management Function (AMF) in the case of a private 5G cellular network or a Mobility Management Entity (MME) in the case of a private 4G cellular network. The authorization request message may include authentication credentials that include an identifier of the UE (referred to herein as a UE identifier) and a MNO network identifier of the MNO's core network to which the UE is provisioned. In examples, the UE identifier may be SIM credentials, a Subscriber Concealed Identifier (SUCI), International Mobile subscriber identity (IMSI), or the like depending on an authentication/authorization protocol to be used at the MNO core network. The MNO network identifier, in some examples, may be a Public Land Mobile Network (PLMN) ID.

The private cellular network may convert the authorization request message from the mobility function to an access request message that requests access to the MNO's core network. The private cellular network may provide the access request message to the NHN connection system, configured prior to receiving the access request message, using a desired authentication/authorization protocol (e.g., Remote Authentication Dial-In User Service (RADIUS), DIAMETER, or the like). The NHN connection system may process the access request message to obtain the MNO network identifier and verify that the MNO offers NHN services to its subscribes using the MNO network identifier to locate and check a corresponding configuration file. If an NHN indicator is found in the configuration file, the NHN connection system can establish an indirect connection between the private cellular network and the MNO's core network specified by the MNO network identifier for the purpose of authenticating (e.g., an authentication channel) the authentication credentials received from the private cellular network. The NHN may route the access request message to the MNO's core network via the authentication channel.

The MNO's core network can authenticate the UE against a database and send an access accept message to the NHN connection system. The NHN connection system may route the access accept message to the private cellular network via the authentication channel. Based on the access accept message, the mobility function of the private cellular network can grant the UE access to the private cellular network using the authentication credentials for accessing the MNO's core network.

As used herein, “message” or “messages” provided or received from components of a network, such as a private cellular network and/or an MNO core network, may be provided as one or more data packets. The messages and contents thereof may be included in a payload of a respective one or more data packets. Data packets may be transmitted over certain interfaces and according to an implemented communication protocol, as described herein. Example protocols include, but are not limited to, RADIUS, DIAMETER, SBI over TLS, and the like. Additionally, the messages referred to herein can be communicated over the RF spectrum over a network interface.

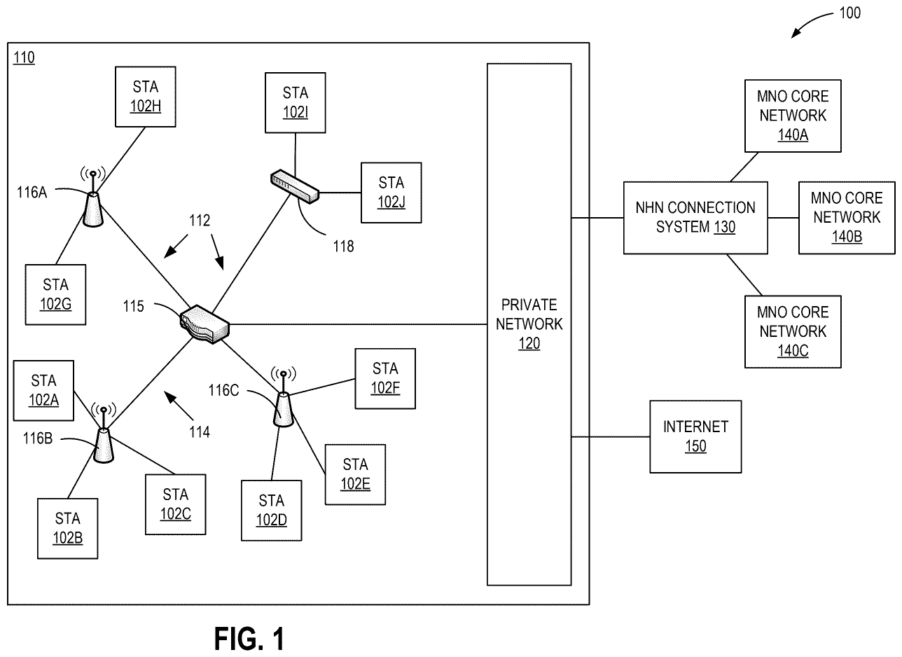

It may be useful to describe an example network installation with which the systems and methods disclosed herein might be implemented in various applications. FIG. 1 illustrates one example of a network configuration 100 that may be implemented for an enterprise, such as a business, educational institution, governmental entity, healthcare facility, or other organization. FIG. 1 illustrates an example of a configuration implemented with an organization having multiple user des (or at least multiple UEs 102A-102J) and a physical or geographical sites 110. Network configuration 100 may include primary site 110 in communication with network 120. Network configuration 100 may also include one or more remote sites (not shown), that are in communication with the network 120.

Primary site 110 may include a primary network, which may be an office network, home network, or other network installation, for example. The primary network may be a private network, such as a network that may include security and access controls to restrict access to authorized users of the private network. Authorized users may include employees of a company at primary site 110, residents of a house, customers at a business, for example.

In the example of FIG. 1, primary site 110 includes controller 115, which is in communication with network 120. Controller 115 may provide communication with network 120 for primary site 110. There may be other points of communication with network 120 for primary site 110 in addition to controller 115. Although single device associated with controller 115 is illustrated, primary site 110 may include multiple controllers and/or multiple communication points with network 120. In some examples, controller 115 may communicate with network 120 through a router. In other examples, controller 115 provides router functionality to the devices in primary site 110. In this specification, the word “tunnel” refers to an encapsulated mode of transporting data between AP and controller.

Controller 115 may be operable to configure and manage network devices, such as at primary site 110, and may manage network devices at remote sites. Controller 115 may be operable to configure and/or manage switches, routers, access points, and/or UEs connected to a network. Controller 115 may itself be, or provide the functionality of, an Access Point (AP).

Controller 115 may be in communication with one or more switches 118 and/or wireless APs 106A-C. Switches 118 and wireless APs 106A-C provide network connectivity to various UEs 102A-J (sometimes referred to herein as stations or STA). Using a connection to switch 118 or AP 116A-C, UE 102A-J may access network resources, including other devices on the (primary site 110) network and network 120.

Examples of UEs 102A-102J may include: desktop computers, laptop computers, servers, web servers, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, any SIM-enabled device, and the like. One of more of the UEs 102A-102J may be SIM-enabled UEs having a SIM provisioned, for example, by an MNO.

Within primary site 110, switch 118 is included as one example of a point of access to the network established in primary site 110 for wired UEs 102I-J. UEs 102I-J may connect to switch 118 and through switch 118, may be able to access other devices within network configuration 100. UEs 102I-J may also be able to access network 120, through switch 118. UEs 102I-J may communicate with switch 118 over a wired or wireless connection 112. In the illustrated example, switch 118 communicates with controller 115 over a wired or wireless connection 112.

Wireless APs 106A-C are included as another example of a point of access to the network established in primary site 110 for UEs 102A-H. Each of APs 106A-C may be a combination of hardware, software, and/or firmware that is configured to provide wireless network connectivity to wireless UEs 102a-h. In the example of FIG. 1, APs 106A-C can be managed and configured by controller 115. APs 106A-C communicate with controller 115 and the network over connections 114, which may be either wired or wireless interfaces.

Network configuration 100 may include one or more remote sites (not shown). Remote site may be located in a different physical or geographical location from primary site 110. In some cases, remote site may be in the same geographical location, or possibly the same building, as primary site 110, but lacks a direct connection to the network located within primary site 110. Instead, remote site may utilize a connection over a different network, e.g., network 120. A remote site may be a satellite office or another floor or suite in a building, for example. A remote site may include gateway device for communicating with network 120, such as a router, a digital-to-analog modem, a cable modem, a digital subscriber line (DSL) modem, or some other network device configured to communicate with network 120. The remote site may also include switches (e.g., similar to switch 118) and/or APs (e.g., similar to APs 116A-C) in communication with the gateway device over either wired or wireless connections. Switch and APs can provide connectivity to the network for various UEs. Thus, the UEs at remote site can access the network resources at primary site 110 as if these UEs were located at primary site. In such examples, the remote site can be managed by controller 115 at primary site 110, and controller 115 provides the necessary connectivity, security, and accessibility that enable the connection between the remote site and primary site 110. Once connected to primary site 110, the remote site may function as a part of a private network provided by primary site 110.

Network 120 may be a private cellular network to allow connectivity among the primary site 110 (and any remote sites). Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities.

In examples, the network 120 may be a private cellular network 120, such as a private 5G cellular network, private 4G cellular network, or the like. In examples, the APs 116A-C, switch 118, and controller 115 can be configured as Passpoint APs, a Passpoint switch, and a Passpoint controller, respectively, that can provide for extending one or more of core networks 140A-140C (collectively referred to herein as core networks 140) to the private cellular network 120. The one or more core networks 140 may be, for example, core networks operated by one or more MNOs.

The private cellular network 120 may be in communication with a NHN connection system 130 configured to enable private cellular networks as NHNs. For example, the NHN connection system 130 may be configured to facilitate indirect connections between the private cellular network 120 and MNO core networks 140 for authenticating UEs 102A-102J for access to the private cellular network 120 using authentication credentials provisioned by the MNO core networks 140. NHN connection system may leverage Passpoint techniques for authenticating UEs 102A-102J using authentication credentials for one or more of core networks 140. In this case, UEs 102A-102J may be subscribed to one or more of the MNOs operating the core networks 140.

In examples, the NHN connection system 130 can be configured to facilitate to provide an indirect connection between the private cellular network and MNO core networks. This indirect connection may be an authentication that the private cellular network can use for authenticating unknown UE. NHN connection system 130 can be configured by associating NHN indicators (e.g., tags, flag, or other indicators) with MNO network identifiers for one or more MNOs based on service information received from or otherwise corresponding to the one or more MNOs. In some examples, service information, such as service definitions, may be included in SLAs that define NHN services offered by the one or more MNOs (e.g., whether such services are offered to subscribers or not). The NHN connection system 130 may receive these SLAs and create configuration files for the one or more MNOs. The configuration files may be associated with MNO network identifiers (e.g., PLMN IDs) associated with the one or more MNOs and may include an indicator specifying whether or not the MNO has enabled (e.g., offers) NHN services to subscribers. If offered, the configuration may include such an indicator that the NHN connection system 130 can process to verify other otherwise determine that the MNO corresponding to the configuration file offers NHN services.

The private cellular network 120 can leverage authentication channel established by the NHN connection system 130 to authenticate UEs 102A-J for access to the private cellular network 120 using authentication credentials for accessing at least one of core networks 140. Said another way, when a UE provisioned by an MNO operating one of core networks 140 attempts to connect to the private cellular network 120, the private cellular network 120 can grant access to the UE based on the one of the core networks 140 authenticating the authentication credentials from the UE passed through the authentication channel established by the NHN connection system 130 configured as set forth above. In examples, the NHN connection system 130 may be implemented as one or more instances of a cloud-based server or other computer system.

In examples, the private cellular network 120 may include various virtualized network functions (NFs), including, for example but not limited to, a mobility function (e.g., an AMF in the case of a private 5G cellular network or an MME in the case of a private 4G cellular network). As an example, assume UE 102A is subscribed to core network 140A operated by a first MNO. When the UE 102A enters the coverage area of the private cellular network 120 (e.g., the primary site 110) and losses connectivity to a RAN of core network 140A, UE 102A may initiate connection with a mobility function of the private cellular network 120 by sending an authorization request to the mobility function of private cellular network 120. The authorization request may include authentication credentials from the UE, which can include an identifier of the UE (e.g., a SIM credentials, SUCI, or the like depending on the authentication/authorization protocol to be used) and a MNO network identifier of the core network 140A (e.g., PLMN ID), among other data. The private cellular network 120 may convert the authorization request to an access request that requests access to a core network operated by an MNO specified by the MNO network identifier, on behalf of the UE.

The private cellular network 120 may send the access request to the NHN connection system 130 using a desired authentication/authorization protocol (e.g., RADIUS, DIAMETER, SBI over TLS, or the like). In examples, the identifier of the UE may be SIM credentials when RADIUS is used as the authentication/authorization protocol. In other examples, the identifier of the UE may be the SUCI associated with the UE when SBI over TLS is used as the authentication/authorization protocol. In yet another example, the identifier of the UE may be the IMSI associated with the UE when DIAMETER is used as the authentication/authorization protocol.

The NHN connection system 130 processes the access request to obtain the MNO network identifier and verifies that the MNO specified by the MNO network identifier permits or offers NHN services to its subscribers. For example, NHN connection system 130 may extract the MNO network identifier from the access request and locates a configuration file corresponding to the MNO network identifier. The NHN connection system 130 determines whether the configuration file includes an NHN indicator and, if so, determines that the MNO corresponding to the MNO network identifier has enabled NHN services for its subscribers. Based on (e.g., in response to) this determination, the NHN connection system 130 may establish an indirect connection between the private cellular network and the MNO's core network specified by the MNO network identifier for the purpose of authenticating the authentication credentials received from the private cellular network 120. In this case, the NHN connection system 130 may then route the access request to the core network 140A as specified by the MNO network identifier. If, however, the configuration file does not include an NHN indicator or a configuration file cannot be located for the MNO network identifier, NHN connection system 130 may not establish the authentication channel and may send an error code back to the private cellular network 120.

The core network 140A may authenticate the UE against its database and send an access accept message to the NHN connection system 130, which routes the access accept message to the private cellular network 120. The core network 140A may use any authentication method known in the art. For example, the core network 140A may use, but not limited to, Extensible Authentication Protocol Authentication and Key Agreement (EAP-AKA); EAP-AKA′, which is an updated version of EAP-AKA; 5G-AKA; Evolved Packet System Authentication and Key Agreement (EPS-AKA), and the like. The core network 140A may be configured to select the desired authentication method based on subscriber data and access registration context data stored in its databases.

The private cellular network 120 may then grant the UE 102A access to the private cellular network based on (e.g., responsive to) the access accept message that represents that the UE 102A is authenticated for access to the core network 140A. In examples, once a UE is granted access to the private cellular network 120, the UE may exchange data with the internet 150 (or other external network) through the private cellular network 120.

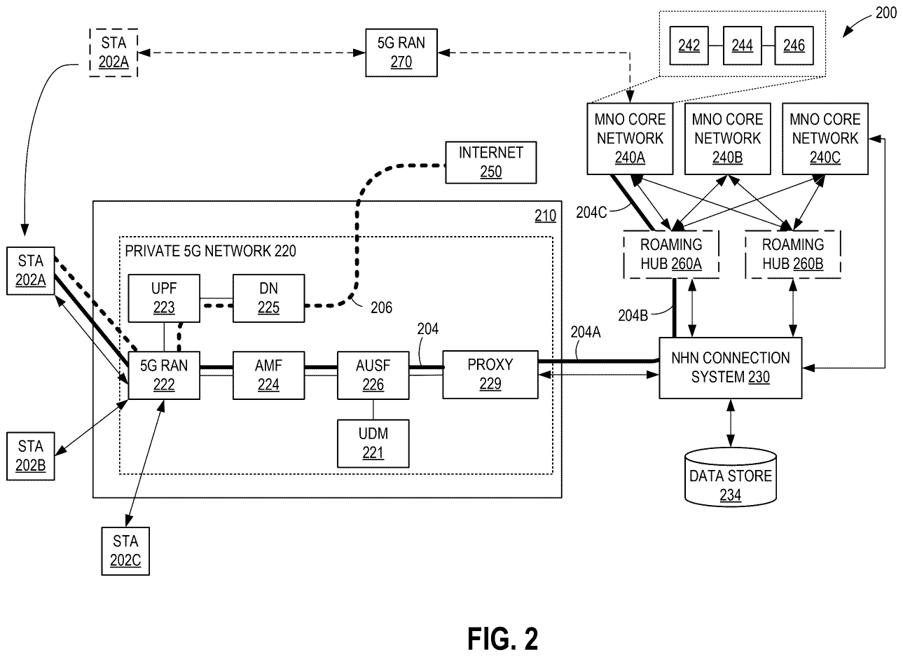

FIG. 2 illustrates an example communication system 200 in which examples of the present disclosure can be implemented. Communication system 200 comprises a private network configuration 210 that may be implemented for an enterprise, such as a business, educational institution, governmental entity, healthcare facility, or other organization. The network configuration 210 may be an example of network configuration 100 of FIG. 1 operating one or more private networks. In the example of FIG. 2, network configuration 210 includes a private 5G cellular network 220. Network configuration 210 may grant one or more mobile devices 202A-202C access to the private 5G cellular network 220.

While the example of FIG. 2 illustrates one private network, examples herein may include multiple networks. For example, network configuration 210 may include the private 5G cellular network 220, as well as a private 4G cellular network and/or a private Wi-Fi network. In another example, network configuration 210 may also include legacy cellular networks (e.g., private 3G or older networks) and/or future generation cellular networks (e.g., a private 6G network).

A cellular network can comprise two component networks, the RAN and the core network. In the case of private 5G cellular network 220, these components are depicted as private 5G RAN 222 and a private 5G core network (private 5GC), which is shown as a collection of NFs. The private 5G RAN 222 operates to connect individual UEs to the private 5GC. The private 5G RAN 222 may include base stations configured according to 5G standards and interfaces with private 5GC network. In various examples, Passpoint functionality may be enabled on the base stations. The private 5G RAN 222 may provide wireless communication coverage for a geographic coverage area of the network configuration 210 (e.g., geographic area or structure of the enterprise). Base stations of the private 5G RAN 222 may include APs (e.g., as described above in connection with FIG. 1), eNB, gNodeB (gNB), or another type of base station. The base stations may operate in the frequency spectrum of 5G, including the low-band spectrum, i.e., the sub-1 GHz spectrum; the mid-band spectrum, i.e., the sub-6 GHz spectrum; and/or the high-band spectrum, e.g., millimeter wave (mmWave) that operates between 25 GHz and 100 GHz.

As alluded to above, the private 5GC may include various NFs, including, for example, AMF 224 in communication with a Unified Data Manager (UDM) 221 via an Authentication Server Function (AUSF) 226. The AMF 224 may receive connection and mobility management tasks from UEs 202A-202C via the private 5G RAN 222 and can handle connection and mobility management tasks, while forwarding session management tasks/messages to a Session Management Function (SMF). AMF 224 may be in communication with AUSF 226 over a Service Based Interface (SBI) for the AUSF 226, such as Nasuf interface. Likewise, the AUSF 226 may be in communication with the UDM 221 over an SBI for UDM 221, such as a Nudm interface. The AMF 224 may authenticate UEs and manage, e.g., handovers, for the UEs between access points, base stations, and gNBs of the private 5G RAN 222.

UDM 221 provides services to other functions of a Service-Based Architecture (SBA), such as AMF 224 and other network functions. UDM 221 may store information in local memory. UDM 221 may also store information externally, for example, within a UDR. UDM 221 may provide authentication credentials while being employed by AMF 224 to retrieve subscriber data and access registration context data. That is, for example, the UDM 221 may store authentication credentials of UEs that are authorized for access to the private 5G cellular network 220.

The AUSF 226 provides for verifying the identity of a user of a UE by handling authentication procedures. The AUSF 226 may decide whether a user is allowed access to the private 5G cellular network 220 based on authentication credentials and interacting with other network function, such as the UDM 221 to retrieve necessary subscriber data to complete the process. Generally, the AUSF 226 may verify authentication credential through a SIM card installed on a UE and provisioned by the operator of the private 5G cellular network 220. The AMF 224 may send an authentication request to the AUSF 226 when a UE attempts to access the private 5G cellular network 220.

The private 5GC may also include a proxy signaling controller 229, which may be a function for controlling the flow messages between the private 5G cellular network 220 and external networks by routing messages between components according to an AAA protocol implemented (e.g., RADIUS, DIAMETER, SBI over Transport Layer Security (TLS), or the like). For example, the proxy signaling controller 229 may operate to convert messages received form NFs of the private 5G cellular network 220 according to HTTP protocol to the desired authentication/authorization protocol. For example, messages received by the proxy signaling controller 229 from the AUSF 226 over the Nausf interface according to HTTP protocol can be converted to RADIUS protocol and sent to external components over a RadSec (e.g., RADIUS over TLS) interface. In another example, the proxy signaling controller 229 may convert messages received according to HTTP protocol to SBI over TLS protocol and send them over an SBI.

The private 5GC may also include a User Plan Function (UPF) 223 that connects the private 5GC to a data network (DN) 225, such as the Internet 250 or other external network. The UPF 223 is a network function that manages data traffic on the private 5G cellular network. UPF 223 may be responsible for packet routing and forwarding, packet inspection, and QoS handling. In examples, once a UE is granted access to the private 5G cellular network 220, the UPF 223 may connect the UE to the DN 225, which can be used to exchange data with the internet 250 (or other external network).

The private 5GC may also include other NFs conventionally included in a 5G core network, such as, but not limited to, a policy control function (PCF), a session management function (SMF), Unified Data repository (UDR), and Network Repository Function (NRF), to name a few.

The NFs of the private 5GC may be implemented as computing systems, such as one or more servers. The NFs of private 5GC may communicate using protocols, such as HyperText Transfer Protocol (HTTP). The NFs may be configured according to 5G standards and interfaces. For example, the NFs may be configured with interfaces according to the protocol utilized for AAA messages. For example, AAA messages may be provided according to the RADIUS protocol over a RadSec (e.g., RADIUS over TLS) interface. In another example, AAA messages can be provided over an SBI over TLS interface using the SBI over TLS protocol.

Communication system 200 also includes one or more cellular networks operated by one or more MNOs. The cellular networks may include corresponding RANs and MNO core networks 240A-240C (collectively referred to herein as MNO core networks 240 or individually as MNO core network 240) that are operated by one or more MNOs. The MNO core networks 240 may be part of respective cellular networks operated by a respective MNO. The MNO core networks 240 may be implemented as any generation of cellular network (e.g., 4G/LTE, 5G, 3G, etc.) The MNO core networks 240 may include various virtualized NFs.

For example, MNO core network 240A, as an illustrative example, may be implemented as a 5G core network. In this case, the MNO core network 240A may include an Authentication-Authorization-Accounting server (AAA) 242, an AUSF 244, and a UDM 246, among other NFs. The NFs of the MNO core network 240A may be implemented as computing systems, such as one or more servers, which may communicate between each other using protocols, such as HyperText Transfer Protocol (HTTP). The AAA 242 may receive AAA messages provided according to RADIUS protocol over a RadSec interface or SBI over TLS protocol over an SBI over TLS interface The AAA 242 facilities access controls on the MNO core network 240A, authenticates valid subscribes of the MNO operating MNO core network 240A to use the MNO's services, and monitors, audits, and accounts actions performed by subscribers. The AUSF 244 provides for verifying the identity of a subscriber by handling authentication procedures. The AUSF 244 may decide whether a subscriber of the MNO is allowed access to the respective network based on authentication credentials and interacting with other network function, such as a UDM 246 of the core network 140A to retrieve subscriber data to complete the process. Generally, the AUSF 244 may verify authentication credential through SIM credentials of a SIM card installed on a UE and provisioned by the operator of the MNO core network 240A. An AMF of the MNO core network 240A may send an authentication request to the AUSF 244 when a UE or other network device attempts to access the MNO core network 240A. The UDM 246 provides services to other functions of a SBA, such as an AMF and other network functions of the MNO core network 240A. UDM 246 may store subscriber data, access registration context data, and other information in local memory. UDM 246 may also store information externally, for example, within a UDR. UDM 246 may provide authentication credentials for access registration context data. That is, for example, the UDM 246 may store authentication credentials of subscribes that are authorized for access to the MNO core network 240A. MNO core network 240A may also include other NFs, such as, but not limited to, AMF, UPF, PCF, SMF, UDR, NFR, etc. as known in the art.

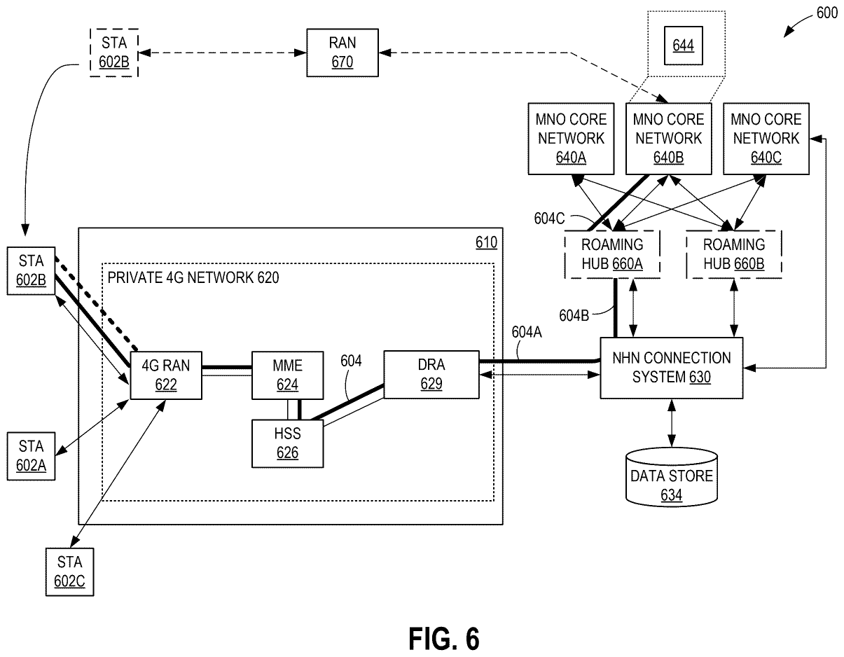

MNO core networks 240B and 240C may comprise similar configurations to that of MNO core network 240A. For example, MNO core networks 240B and/or 240C may be 5G core networks comprising an AMF, UDM, AUSF, UPF, PCF, SMF, UDR, NFR, etc. In another example, one or more of MNO core networks 240A-240B may be different core networks, such as an EPC or other legacy cellular network (e.g., as described below in the example of FIG. 6). In the case of EPC, the core networks may include an AAA, MME, and HSS, among other NFs as known in the art.

In examples, the private 5G cellular network 220 may be configured to provide a NHN that extends one or more MNO core networks 240A-240C to the private 5G cellular network 220. For example, communication system 200 includes a NHN connection system 230, which may be an example implementation of NHN connection system 130 of FIG. 1. The NHN connection system 230 may be configured to provide Passpoint solutions for authenticating UEs for access to the private 5G network 220 using authentication credentials provisioned by one or more of MNO core networks 240. In this case, UEs 202A-202C may be subscribed to one or more of the MNOs operating the MNO core networks 240. The NHN connection system 230 may be configured with service information (e.g., SLAs) corresponding to MNOs that specify those MNOs that have enabled NHN services with the NHN connection system 230. In examples, the service information may be extracted from SLAs and used to generate configuration files that may be stored according to MNO network identifiers (e.g., PLMN ID) of the MNO party to the SLA, as described above. The configuration files and MNO network identifiers can be stored to a data store 234.

As an illustrative example, UE 202A may be connected to MNO core network 240A via 5G RAN 270. In this case, UE 202A may be provisioned by the MNO that operates the MNO core network 240A and, as such, MNO core network 240A may store authentication credentials for the UE 202A. When UE 202A moves into the geographic area or structure serviced by private network configuration 210, UE 202A may attempt a handover from the MNO core network 240A to the private 5G cellular network 220, for example, when connectivity with the MNO core network 240A via 5G RAN 270 is lost (e.g., connection with the 5G RAN 270 is below a threshold RSSI value or similar metric). The UE 202A may establish a connection with the private 5G RAN 222, according to known techniques.

Once a connection is established, the UE 202A may initiate registration with the private 5G cellular network 220. For example, the UE 202A may send a registration request message to the AMF 224. The AMF 224 may respond with a UE ID request message to UE 202A and the UE 202A may respond with a UE response message. The UE response message may include authentication credentials, such as an identifier of the UE 202A (e.g., SIM credentials, SUCI, or the like depending on the authentication/authorization protocol be used at the MNO core network) and a MNO network identifier of the MNO's core network to which the UE is provisioned (e.g., a PLMN ID).

The AMF 224 may extract the UE identifier and construct an authorization request message requesting authentication of the UE identifier by the UE identifier. The private 5G network 220 may convert the authorization request message to an access request message that requests access to a MNO core network 240 corresponding to the MNO network identifier.

The access request message can be sent to the NHN connection system 230 using a desired authentication/authorization protocol (e.g., RADIUS, DIAMETER, or the like). The NHN connection system 230 processes the authorization request to obtain the MNO network identifier and checks for a configuration file in data store 234 corresponding to the MNO network identifier. As described above, the configuration files are generated from service information in SLAs with the MNOs. If a configuration file for the MNO network identifier is found in the data store 234, the NHN connection system 230 checks the configuration file for a NHN indicator indicative of whether or not the MNO has enabled NHN services. If NHN services are enabled, the NHN connection system routes the authorization request to the core network of the MNO specified by the MNO network identifier (e.g., MNO core network 240A in this example as shown as authentication path 204). The MNO core network 240A authenticates the UE 202A against its database using the identifier of the UE according to the desired authentication/authorization protocol and, once authenticated, sends an access accept message to the NHN connection system 230. During the above process, the NHN connection system 230 may maintain an association between the authorization request and the private network identifier.

The NHN connection system 230 routes the access accept message to the AMF 224 using the private network identifier to locate the originating private 5G cellular network 220. The AMF 224 can grant the UE 202A access to the private 5G cellular network 220 based on (e.g., responsive to) the access accept message. Once granted, data traffic from UE 202A can be routed to the DN 225 (and ultimately to the internet 250 or other external network) through UPF 223, shown as data traffic path 206.

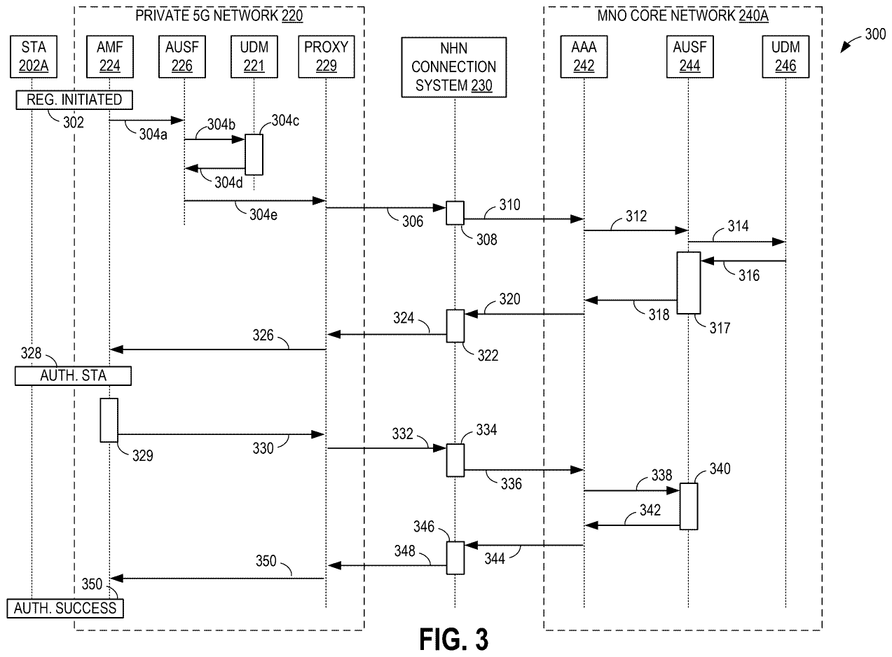

FIG. 3 illustrates an example message flow 300 for authenticating a UE for access to a NHN, in accordance with an example disclosed herein. Message flow 300 may be performed by the communication system 200 and thus will be described with reference to FIG. 2 as an illustrative example. FIG. 3 illustrates an authentication approach in which a UE, such as UE 202A, can be authenticated for access to the private 5G cellular network 220 as a NHN using the 5G-AKA method.

In the example of FIG. 3, the private 5G cellular network 220 may start an authentication procedure upon receiving signaling messages from the UE 202A. For example, the UE 202A may establish a connection with the private 5G RAN 222, for example, upon entering the coverage area of the private 5G cellular network 220 and attempting a handover from an MNO core network. Upon establishing the connection, the AMF 224 may initiate registration 302 of the UE 202A on the private 5G cellular network by requesting authentication credentials from the UE 202A and the UE 202A may respond with its authentication credentials.

In the example of FIG. 3, the authentication credentials may be SIM credentials of UE 202A, which may include an identifier of the UE 202A and the MNO network identifier of, for example, the MNO core network 240A to which the UE 202A is provisioned, in this example.

In the example of FIG. 3, once the AMF 224 receives the SIM credentials of UE 202A, the AMF 224 forwards an authentication request message 304a to the AUSF 226 that includes the SIM credentials. In examples, AMF 224 may forward the authentication request message 304a over the Nausf interface. The AUSF 226 may attempt to verify the SIM credentials by interacting with the UDM 221. For example, the AUSF 226 may send a get authentication request message 304b to the UDM 221 to authenticate the SIM credentials, for example, using a Nudm interface. The authentication request message 304b may be a Nudm_UEAuthentication_Get_Request that includes the SIM credentials. At process 304c, the UDM 221 attempts to authenticate the SIM credentials by decrypting the SUCI and checking against access registration context data for the SUPI. However, in this case, the UDM 221 is unable to authenticate the SIM credentials because it does not have the corresponding private key, nor is the UE 202A registered with the UDM 221. The UDM 221 responds to the AUSF 226 with authentication failed response message 304d, for example, as Nudm_UEAuthentication_Get_Response over the Nudm interface.

Responsive to the failed authentication, the AUSF 226 constructs authentication request message 304e and sends the authentication request message 304a to proxy signaling controller 229. For example, the AUSF 226 may provide authentication request message 304e over the Nausf interface as Nausf_UEAuthentication_authentication_request (SIM credentials).

The proxy signaling controller 229 forwards the authentication request message 304e to the NHN connection system 230 as an access request message 306. For example, the proxy signaling controller 229 converts the authentication request message 304e sent using HTTP protocol to the RADIUS protocol and transmits the access request message 306 over the RadSec interface. In an example, the access request message may be provided as “RADIUS: Access-Request (SIM credentials). The access request message 306 may be operated to request access to the MNO core network 240A for the SIM credentials included in the access request message 306).

The NHN connection system 230 can be configured to identify a MNO core network 240 for the access request message 306 by processing the access request message 306. The NHN connection system 230 may execute process 308 to obtain the SIM credentials and extract the MNO network identifier therefrom (e.g., extract the PLMN ID from the “realm” of the SIM credentials). The NHN connection system 230 may be configured with service information and configuration files as described above prior to receiving access request 306. Process 308 may check the data store 234 for a configuration file corresponding to the MNO network identifier for the MNO core network 240A. If a configuration file is located, the NHN connection system 230 determines if the configuration file contains an NHN indicator indicative that the MNO has offers NHN services to its subscribers. If the NHN indicator is present, the NHN connection system 230 determines that the MNO corresponding to the MNO network identifier has enabled NHN services for its subscribers. Based on (e.g., in response to) this determination, the NHN connection system 230 establishes an authentication channel (e.g., indirect connection) between the private cellular network and the MNO's core network specified by the MNO network identifier for the purpose of authenticating the authentication credentials received from the private cellular network 120. The indirect connection (e.g., authentication channel) is illustratively depicted in FIG. 2 as portions 204A-204C of the authentication path 204. In this case, the NHN connection system routes the access request message 306 to the MNO core network 240A identified by the SLA as access request message 310. The access request message 310 may be substantially similar to the access request message 306. In some examples, the NHN connection system 230 may route the access request directly to the MNO core network 240. In another example, the NHN connection system 230 may forward the authorization request to the MNO core network 240A via optional roaming proxy hubs 260A and/or 260B. These roaming proxy hubs 260A and 260B may be proxy partners that connect to multiple MNOs for handling intermediate routing to the appropriate network, as known in the art.

If a configuration file for the MNO network identifier is not present in the data store 234 or the located configuration file does not include an NHN indicator, the NHN connection system 230 may send an error code back to the private 5G cellular network 220 using the private network identifier. As a result, the UE 204A may not be granted access to the private 5G cellular network 220.

Upon receiving the access request message 310, the MNO core network 240A may authenticate the UE 202A against its database using the SIM credentials according to the 5G-AKA method. For example, the AAA 242 receives access request message 310 according over the RadSec interface according to the RADIUS protocol and converts the message 310 to the HTTP protocol for transmission to the AUSF 244 over a Nausf interface of the MNO core network 240A as authentication request message 312. For example, the AAA 242 converts the access request message 310 to an authentication request message 312, which can be provided as Nausf_UEAuthenticate_AuthenticateRequest over the Nausf interface. The message 312 may include the SNid of the private 5G cellular network 220 and SIM credentials of the UE 202A.

The AUSF 244 receives the authentication request message 312 and verifies the private 5G cellular network 220 requesting authentication services is authorized for such services. The AUSF 244 may check the SNid against stored identifiers of authorized private cellular networks and, if present, verifies the private 5G cellular network 220. Upon verification, the AUSF 244 sends a get authentication request message 314 to the UDM 246 to authenticate the SIM credentials, for example, using a Nudm interface of the MNO core network 240A. The get authentication request message 314 may be a Nudm_UEAuthentication_Get_Request that includes the SIM credentials and the SNid.

Upon receiving message 314, the UDM 246 may obtain the SIM credentials and extract the SUCI. The SUCI can be decrypted to obtain the SUPI, which can be used to select the authentication method configured for the subscriber corresponding to the SUPI. In this case, the authentication method is 5G-AKA. 5G-AKA may be initiated by sending a get authentication response message 316 to the AUSF 244 with an authentication vector (AV) and the SUPI. The AV may include an authentication (AUTH) token and an expected response (XRES) token, among other data. The XRES token may be specific to the subscriber and obtained by the UDM, for example, from the access registration context data using the SUPI to locate the information for the subscriber. The AUTH token may be associated with the MNO core network 240A. In an example, UDM 246 may transmit the get authentication response message 316, for example, as Nudm_UEAuthentication_Get_Response (AV, SUPI) over the Nudm interface.

The AUSF 244 executes process 317 to obtain the AV from the get authentication response message 316 and compute a hash of XRES (HXRES). The AUSF 244 stores the XRES, and HXRES and builds an authentication response message 318. The authentication response message 318 may include the AV, as well as the HXRES, SUCI, and the SNid. The AUSF 244 may provide authentication response message 318 to the AAA 242 over the Nausf interface as Nausf_UEAuthentication_AuthenticateResponse (AV, SUCI, SNid).

The AAA 242 converts the authentication response message 318 sent using HTTP protocol to the RADIUS protocol and transmits the authentication response message 318 to the NHN connection system 230 as access challenge message 320 over the RadSec interface. The access challenge message 320 may include the AV, as well as the HXRES, SUCI, and SNid. In an example, the access challenge message 320 may be provided as “RADIUS: Access-Challenge (AV, SUPI, SNid).

The NHN connection system 230 routes the access challenge message 320 to proxy signaling controller 229 via the authentication channel 204A-204C. For example, the NHN connection system 230 executes process 322 to obtain the SNid from the access challenge message 320 and identify the private 5G cellular network 220 that originated the authentication request message corresponding to the access challenge message 320 (e.g., message 306). The network management 220 may locate the corresponding authentication channel and forward the access challenge message 320 to the proxy signaling controller 229 of the identified private 5G cellular network 220 as access challenge message 324.

The proxy signaling controller 229 forwards the access challenge message 320 to the AMF 224 as an authentication response message 326. For example, the proxy signaling controller 229 converts the access challenge message 324 received according to RADIUS protocol over the RadSec interface to HTTP protocol and transmits the authentication response message 326 over the Niwf interface. The authentication response message 326 may be provided as Niwf_UEAuthenticate_authenticate_Response (AV, SUPI).

The AMF 224 authenticates 328 the UE 202A based on the contents of the authentication response message 326. For example, the AMF 224 obtains the AV from the authentication response message 326 and extracts the HXRES and AUTH token. The HXRES can be stored to a memory and the AUTH token can be transmitted to the UE 202A as an authentication request. The UE 202A validates the AUTH token by using a secret key (Kᵢ) shared with the MNO core network 240A. If the AUTH token is successfully validated, the UE 202A considers the private 5G cellular network to be authenticated. The UE 202A may continue authentication by computing a response (RES) token and sending the RES token to the AMF 224 in a authentication response message. The AMF 224 computes a hash of the RES token (HRES) and compares the HRES to the HXRES to validate the response at process 329. If the HRES and HXRES are substantially equal, the AMF 224 considers the UE 202A validated.

Based on successful validation, the AMF 224 then constructs an authentication request message 330 that includes the RES token, the SIM credentials, and SNid. The authentication request message 330 can be provided to the proxy signaling controller 229, for example, over the Niwf interface as Niwf_UEAUthenticate_authenticate_Request (RES, SIM credentials, SNid).

The proxy signaling controller 229 forwards the authentication request message 330 to the NHN connection system 230 as an access request message 332. For example, the proxy signaling controller 229 converts the authentication request message 330 sent using HTTP protocol to the RADIUS protocol and transmits the access request message 332 over the RadSec interface. In an example, the access request message may be provided as “RADIUS: Access-Request (RES, SIM credentials).

The NHN connection system 230 can be configured to identify a MNO core network 240 for the access request message 332 by processing the access request message 332. For example, the NHN connection system 230 may execute process 334 to obtain the SIM credentials and extract the MNO network identifier therefrom, similar to process 308 described above. The NHN connection system 230 may route the access request message 332 to AAA 242 as access request message 336 over the authentication channel 204A-204C. AAA 242 converts the access request message 332 to the HTTP protocol for transmission to the AUSF 244 over a Nausf interface as authentication request message 338, for example, as described above in connection with authentication request message 312. The authentication request message 338 may include the SNid of the private 5G cellular network 220, the SIM credentials of the UE 202A, and the RES.

The AUSF 244 performs process 340 to make the final decision on authentication. For example, the AUSF 244 obtains the RES from authentication request message 338 and verifies that the RES token matches (e.g., is substantially equal to) the XRES token. If the RES token is valid, the AUSF 244 computes an anchor key (K_{SEAF}) and sends it to the private 5G cellular network 220, along with the SUPI, as authentication response message 342. The AUSF 244 may provide authentication response message 342 to the AAA 242 over the Nausf interface as Nausf_UEAuthentication_AuthenticateResponse (Success, SUPI, K_{SEAF}, SNid). The AAA 244 converts the authentication response message 342 sent using HTTP protocol to the RADIUS protocol and transmits the authentication response message 342 to the NHN connection system 230 as access accept message 344 over the RadSec interface. The access accept message 344 may include the success identification, as well as the SUCI, SNid, and K_{SEAF}. In an example, the access accept message 344 may be provided as “RADIUS: Access-Accept (Success, SUPI, K_{SEAF}).

The NHN connection system 230 routes the access accept message 344 to proxy signaling controller 229 through the authentication channel 204A-204C. For example, the NHN connection system 230 executes process 346 to obtain the SNid from the access accept message 344 and identify the private 5G cellular network 220. The NHN connection system 230 may forward the access accept message 344 to the proxy signaling controller 229 of the identified private 5G cellular network 220 as access accept message 348.

The proxy signaling controller 229 forwards the access accept message 348 to the AMF 224 as an authentication response message 350. For example, the proxy signaling controller 229 converts the access accept message 348 received according to RADIUS protocol over the RadSec interface to HTTP protocol and transmits the authentication response message 350 over the Niwf interface. The authentication response message 350 may be provided as Niwf_UEAuthenticate_authenticate_Response (Success, SUPI, K_{SEAF}). Upon receiving the authentication response message 350, authentication process is complete 352 and the UE 202A can be granted access to the private 5G cellular network.

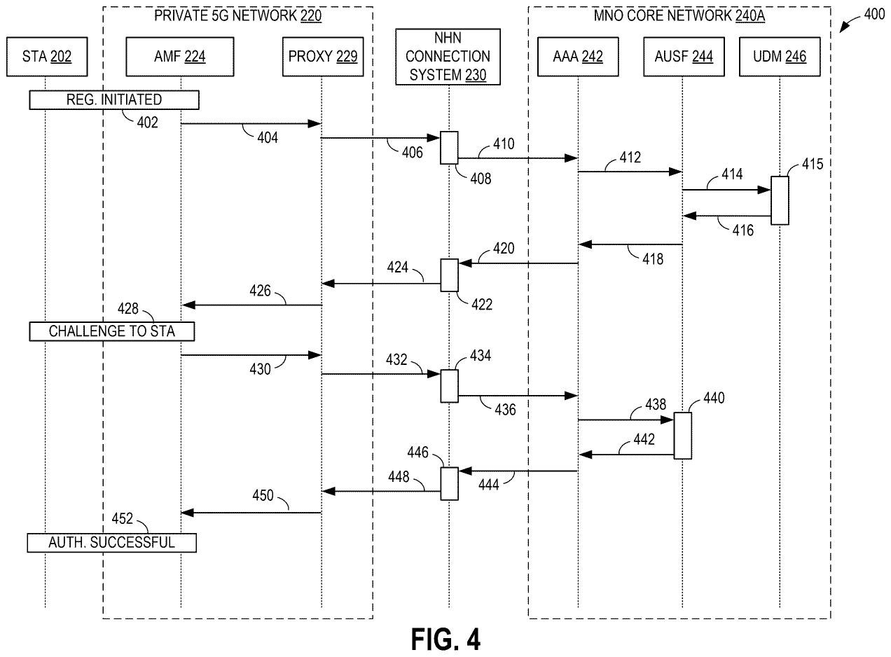

FIG. 4 illustrates an example message flow 400 for authenticating a UE for access to a NHN, in accordance with an example disclosed herein. Message flow 400 may be performed by the communication system 200 and thus will be described with reference to FIG. 2 as an illustrative example. FIG. 4 illustrates an authentication approach in which a UE, such as UE 202A, can be authenticated for access to the private 5G cellular network 220 as a NHN using the EAP-AKA′ method.

The messages of FIG. 4 may be similar to the messages of message flow 300 of FIG. 3. Thus, FIG. 4 follows a numbering convention in which the first digit corresponds to the FIG. 4 and the remaining digits identify a message in the drawing. For example, reference numeral 306 refers to message “306” in FIG. 3 and an analogous message may be identified by reference numeral 406 in FIG. 4. Description with respect to one analogous element may apply to other analogous messages, unless specified herein. For example, messages 406-414 may be analogous to messages 306-314 of FIG. 3 and the description above with to messages 306-314 may apply equally to messages 406-414.

Similarly, messages 416-452 may be analogous to messages 316-352 and the description in connection with FIG. 3 above may apply to messages 416-452. However, in the example of FIG. 4, upon receiving message 414, the UDM 246 may extract the SUCI and obtain the SUPI, as described above, and select the authentication method configured for the subscribe, which in the case of FIG. 4 is the EAP-AKA′ method. EAP-AKA′ may be initiated by the UDM 246 to generate an EAP-AKA′ AV at process 415 from the get authentication request message 315. The EAP-AKA′ AV may include an expected AKA′ response and an AKA′-challenge, among other data. The AKA′-challenge may include an AUTH token, a key derivation function (KDF), a MAC (Message Authentication Code), and the network identifier of the MNO core network 240A, among other data. The UDM 246 may send get authentication response message 416 to the AUSF 244 with the EAP-AKA′ AV and the SUPI. The EAP-AKA′ AV can be in place of the AV used in the 5G-AKA method. As such, messages 418-426 are substantially similar to messages 318-326, except messages 418-426 include the AKA′-challenge instead of the AV.

At authentication 428, the AMF 224 authenticates the UE 202A based on the contents of authentication response message 426. For example, the AMF 224 obtains the AKA′-challenge from the authentication response message 426 and provides the AKA′-challenge to the UE 202A, which provides an AKA′-challenge response to the AMF 224. The AKA′-challenge sent to the UE 202A at authentication 428, may include the AUTH token, MAC, KDF, and network identifier. The UE 202A validates the AUTH token by using the shared secret key (Kᵢ) and computes a response (RES) token to the AKA′-challenge, which is included in the AKA′-challenge response. The AMF 224 then constructs an authentication request message 430 that includes the AKA′-challenge response, the SIM credentials, and SNid. The authentication request message 430 can be provided to the proxy signaling controller 229, for example, over the Niwf interface as Niwf_UEAUthenticate_authenticate_Request (AKA′-challenge response, SIM credentials, SNid).

Messages 432-438 may be similar to messages 332-338, except that the RES token in each message can be replaced with the AKA′-challenge response (which may include a RES token). Upon receiving authentication request message 338 with the AKA′-challenge response, AUSF 244 performs process 340 to make the final decision on authentication by verifying the EAP-AKA′ response against the expected EAP-AKA′ response. If the EAP-AKA′ response is valid (e.g., substantially the same as the expected EAP-AKA′ response), the AUSF 244 computes an anchor key (K_{SEAF}) and sends it to the private 5G cellular network 220, along with the SUPI, as authentication response message 442, similar to authentication response message 342 described above. Messages 444-452 then proceed in a manner substantially similar to message 344-352 of FIG. 3.

Additionally, in the example of FIG. 4, UE 202A and AMF 224 initiate registration 402 in a manner similar to initiating registration 302 described above. In the example of FIG. 4, once the AMF 224 receives the SIM credentials of UE 202A, the AMF 224 sends an authentication request message 404 to the proxy signaling controller 229. The authentication request message 404 may be substantially similar to the authentication request message 304e, except that authentication request message 404 may be provided by the AMF 224 over the Niwf interface as Niwf_UEAuthentication_authentication_reqeust (SNid, SIM credentials). In this case, AMF 224 may be configured to determine that the UE 202A is not authenticated for access to the private 5G cellular network 220. For example, the AMF 224 can be configured to obtain a MNO network identifier from the SIM credentials. In this example, the SIM credentials would include the MNO network identifier (e.g., the PLMN ID) and the AMF 224 can determine that the network specified by the MNO network identifier in the SIM credentials is not part of the private 5G cellular network 220 (e.g., the PLMN ID is not recognized by the AMF 224). Based on this determination, the AMF 224 may construct the authentication request message 404 and send it to the proxy signaling controller 229, without inquiring with the AUSF 226 and/or UDM 221.

In another example, message flow 400 may include messages 304a-304e in place of authentication request message 404. Thus, message flow 400 may reference the AUSF 226 and/or UDM 221 as described above in connection with FIG. 3. Likewise, message flow 300 may replace messages 304a-304e with authentication request message 404, thereby sending an authentication request message directly to the proxy signaling controller 229.

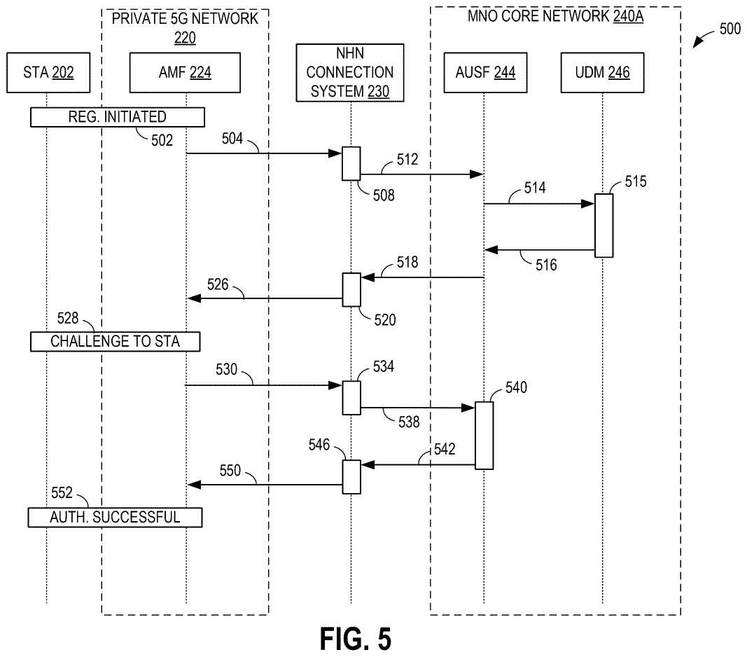

FIG. 5 illustrates another example message flow 500 for authenticating a UE for access to a NHN, in accordance with an example disclosed herein. Message flow 500 may be performed by the communication system 200 and thus will be described with reference to FIG. 2 as an illustrative example. FIG. 5 illustrates an authentication approach in which a UE, such as UE 202A, can be authenticated for access to the private 5G cellular network 220 as a NHN using the EAP-AKA′ method over SBI, opposed to RADIUS as described in connection with FIG. 4. Thus, for example, the private 5G cellular network 220 may be able to provide messages to an MNO core network 240 (e.g., MNO core network 240A in this example) over an SBI using SBI over TLS protocol. More particularly, in the example of FIG. 5, the AMF 224 may send messages to AUSF 244 via the NHN connection system 230.

The messages of FIG. 5 may be similar to the messages of message flow 400. Thus, FIG. 5 follows a numbering convention in which the first digit corresponds to the FIG. 4 and the remaining digits identify a message in the drawing. For example, reference numeral 404 refers to message “404” in FIG. 4 and an analogous message may be identified by reference numeral 506 in FIG. 5. Description with respect to one analogous element may apply to other analogous messages, unless specified herein. Note that certain messages shown in FIG. 4 are not included in FIG. 5 by virtue of using an SBI to communicate messages between the private 5G cellular network 220 and the MNO core network 240A.

For example, messages 502-552 may be analogous to messages 402-452 of FIG. 4 and the description above with to messages 402-452 may apply equally to messages 502-552. However, in the example of FIG. 5, the SUCI can be included in the authentication request message 504 by virtue of using the SBI. In this case, authentication request message 504 may be provided by the AMF 224 over the Nausf interface of the MNO core network 240A as Nausf_UEAuthentication_authentication_Reqeust (SNid, SUCI). The message flow 500 proceeds in a manner similar to that of message flow 400, except that certain messages with AAA 242 and the proxy signaling controller 229 may be excluded due to the use of an SBI for communications.

FIG. 6 illustrates an example of communication system 600 in which examples of the present disclosure can be implemented. Communication system 600 comprises a private network configuration 610 that may be implemented for an enterprise, such as a business, educational institution, governmental entity, healthcare facility, or other organization. The network configuration 610 may be an example of network configuration 100 of FIG. 1 operating one or more private networks. In the example of FIG. 6, network configuration 610 includes a private 4G cellular network 620. Network configuration 610 may grant one or more UEs 602A-602C, which may be the same as or substantially similar to the UEs 202A-202C of FIG. 2, access to the private 4G cellular network 620.

While the example of FIG. 6 illustrates one private network, examples herein may include multiple networks. For example, network configuration 610 may include the private 4G cellular network 620, as well as a private 5G cellular network (e.g., private 5G cellular network 220 of FIG. 2) and/or a private Wi-Fi network. In another example, network configuration 610 may also include legacy cellular networks (e.g., private 3G or older networks) and/or future generation cellular networks (e.g., a private 6G network).

In the case of FIG. 6, the private 4G cellular network 620 may include a private RAN 622 and a private EPC, which is shown as a collection of NFs. The private RAN 622 operates to connect individual UEs to the private EPC. The private RAN 622 may include base stations configured according to 4G/LTE standards and interfaces with private EPC. In various examples, Passpoint functionality may be enabled on the base stations. The private RAN 622 may provide wireless communication coverage for a geographic coverage area of the network configuration 610 (e.g., geographic area or structure of the enterprise). Base stations of the private RAN 622 may include APs (e.g., as described above in connection with FIG. 1), eNB, gNodeB (gNB), or another type of base station. The base stations may operate in the frequency spectrum of 4G/LTE.

The private EPC includes various NFs, including, for example but not limited to, one or more MMEs 624 (sometimes referred to as a Mobility Management Devices (MMDs)), a Home Subscriber Server (HSS) 626, and a Diameter Routing Agent (DRA) 629. The private EPC may also include a Serving Gateway (S-GW), and a Packet Data Network (PDN) Gateway, among other network function entities. The MME 624 may receive connection and mobility management tasks from UEs 602A-602C via the private RAN 622 and can handle connection and mobility management tasks, while forwarding.

The MME 624 may be in communication with HSS 626 over a designated interface, for example, a DIAMETER interface used for exchange of authentication, location, and server information about subscribers between the HSS 626 and MME 624. The MME 624 may function as control nodes that process signaling between the UEs 602A-602C and the private EPC, including providing bearer and connection management functionality. The PDN Gateway may be connected to IP Services, such as the Internet, an intranet, an IP Multimedia Subsystem (IMS), a Packet-Switched (PS) Streaming Service, and/or other IP services.

The HSS 626 may be a database that store subscriber information. Subscriber information can include authentication keys, service profiles, and location data, among other data indexed according to subscribers. For example, subscriber data may be indexed by a UE identifier, such as an IMSI. Thus, the HSS 626 may hold subscription information for subscribers that are authenticated for access to the private 4G cellular network 620.

The DRA 629 is a NF that provides routing capabilities and ensure messages are routed correctly among the NFs. For example, the DRA 629 can be configured to ensure that messages received are routed to the internal function or external system, where appropriate.

The NFs of the private EPC may be implemented as computing systems, such as one or more servers. The NFs of the EPC may communicate using protocols, such as the DIAMETER Protocol. For example, the DIAMETER Protocol may be used for messages between the MME 624 and the HSS 626 or the DRA 629 and the HSS 626. Data included in the messages on the EPC may be formatted according to American Standard Code for Information Interchange (ASCII) protocols

Communication system 600 also includes one or more cellular networks operated by one or more MNOs. The cellular networks may include corresponding RANs and MNO core networks 640A-540C (collectively referred to herein as MNO core networks 640 or individually as MNO core network 640) that are operated by one or more MNOs. MNO core networks 640 may be the same or substantially similar to MNO core networks 240, described above in connection with FIG. 2. Thus, the MNO core networks 640 may be part of respective cellular networks operated by a respective MNO and may include virtualized NFs as described above.

As an example, MNO core network 640B may be implemented as an EPC. In this case, the MNO core network 640B may include an HSS 644, among other NFs as known in the art. The NFs of the MNO core network 640B may be implemented as computing systems, such as one or more servers, which may communicate between each other using protocols, such as DIAMETER protocol. The HSS 644 is a database storing subscriber information for subscribers of the MNO corresponding to MNO core network 640B that can be used to authenticate UEs attempting to connect to the EPC. The HSS 644 can be accessed for verifying the identify of subscribers by retrieving subscriber information for authentication. In the context of a Global System for Mobile Communication (GSM) network, the HSS functions may be provided by an Authentication Center (AuC).

In examples, the private 4G cellular network 620 may be configured to provide a NHN that extends one or more MNO core networks 640 to the private 4G cellular network 620. For example, communication system 600 includes a NHN connection system 630 configured to provide Passpoint solutions for authenticating UEs using authentication credentials provisioned by one or more of MNO core networks 640. The NHN connection system 630 may be the same or substantially similar to NHN connection system 230, described above in connection with FIG. 2. UEs 602A-602C may be subscribed to one or more of the MNOs operating the MNO core networks 640 and the MNOs may provision Passpoint profiles. The NHN connection system 630 may be configured according to SLAs with MNOs specifying which MNOs have enabled NHN services with the NHN connection system 630 stored according to MNO network identifiers (e.g., PLMN ID), for example, as described above in connection with FIGS. 1-3.

In some examples, the NHN connection system 630 may establish an authentication channel 604A-604C and forward access requests to the MNO core networks 640 via optional roaming proxy hubs 660A and/or 660B. These roaming proxy hubs 660A and 660B may be the same as substantially similar to the roaming proxy hubs 260A and/or 260B of FIG. 2.

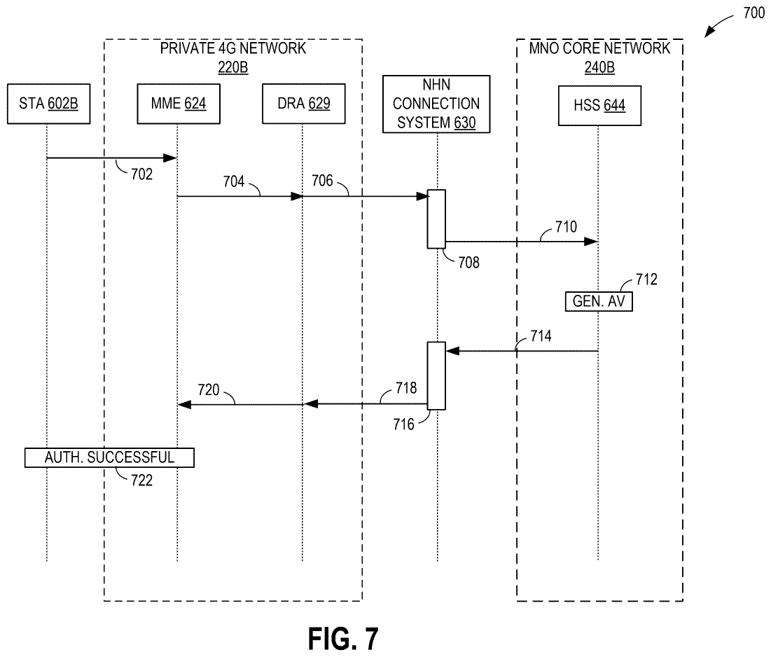

FIG. 7 illustrates an example of a message flow 700 for authenticating a UE for access to a NHN on the communication system 600, in accordance with an example disclosed herein. The message flow 700 may be performed by the communication system 600. FIG. 6 illustrates an authentication approach in which a UE, such as UE 602B, can be authenticated for access to the private 5G cellular network 220 as a NHN using the EPS-AKA method over a DIAMETER interface using DIAMETER protocol.

Prior to message flow 700, UE 602B may be connected to MNO core network 640B via RAN 670. In this case, UE 602B may be provisioned by the MNO that operates the MNO core network 640B and, as such, MNO core network 640B may store authentication credentials for the UE 602B at HSS 644. When UE 602B moves into the geographic area or structure serviced by private network configuration 610, UE 602B may attempt a handover from the MNO core network 640B to the private 4G cellular network 620. The UE 602A may establish a connection with the private RAN 622 by completing a Radio Resource Control (RRC) procedure, according to known techniques.

One the connection is established, the UE 602B may initiate attachment with the private 4G cellular network 620. For example, the UE sends an Attach Request message 702 to the MME 624, The Attach Request message 702 may include authentication credentials for the UE 602A. The authentication credentials may include, among other data, the identifier of the UE 602B (e.g., the IMSI of the UE) and a MNO network identifier of the MNO's core network to which the UE is provisioned (e.g., a PLMN ID of MNO core network 640B in this example). In an example, the authentication credentials may be SIM credentials of UE 602B provided in NAI format. For example, the SIM credentials may be provided as “username@realm”, where the “username” is the UE identifier (e.g., IMSI in this example) and “realm” includes the MNO network identifier of the provisioning MNO core network. In examples, “realm” can be provided as “epc.mnc<MNC>.mcc<MCC>.3ggpnetwork.org”, where “epc” indicates that the SIM credentials are 4G credentials.

The MME 624 may send an Authentication Request message 704 (an example of an access request message in this example) destined for the HSS 644 of the MNO core network 640B. The Authentication Request message 704 may include the UE identifier and the private network identifier of the private 4G cellular network 620 (e.g., the SNid of the private 4G cellular network 620). The Authentication Request message 704 may be communicated using a desired authentication/authorization protocol (e.g., DIAMETER or the like). For example, the Authentication Request message 704 may be provided as “Authenticate Information Request (SNid, IMSI)” communicated according to DIAMETER protocol.

The Authentication Request message 704 is sent to the DRA 629, which routes the Authentication request message 704 to the NHN connection system 630 over, for example, a DIAMETER interface, as Authentication Request message 706. The NHN connection system 630 processes the Authentication Request message 706 at process 708 to obtain the MNO network identifier and checks for a configuration file in data store 634 corresponding to the MNO network identifier. Process 708 may be substantially similar to process 308 of FIG. 3, described above. If a configuration file for the MNO network identifier is found in the data store 634 and determined to include an NHN indicator, the NHN connection system 630 establishes the authentication channel 604A-604C and routes the Authentication Request message 706 to the HSS 644 on MNO core network of the MNO specified by the MNO network identifier (e.g., MNO core network 640B in this example) as Authentication Request message 710 (e.g., MNO core network 640B in this example as shown as authentication path 604 of FIG. 6).

At process 712, the HSS 644 generates an AV based on the Authentication Request message 710. For example, HSS 644 performs cryptographic operations based on a secret key (Kᵢ) shared with the UE to derive the AV. The AV can include an AUTH token and an XRES token, among other data.

The HSS 644 sends the AV to the MME in an Authentication Response message via the authentication channel 604A-604C. For example, the HSS 644 transmits an Authentication Response message 714 to the NHN connection system 630. For example, the Authentication Response message 714 may be provided as “Authenticate Information Answer (SNid, AV)” communicated according to DIAMETER protocol. The NHN connection system 630 routes the Authentication Response message 714 to DRA 629 as Authentication Response message 718. For example, the NHN connection system 630 executes process 716, which may be substantially similar to process 322, to obtain the SNid from the Authentication Response message 714 and identify the private 4G cellular network 620 that originated the Authentication Request message 706. The NHN connection system 630 then forwards the Authentication Response message 714 to the DRA 629 as Authentication Response message 718. The DRA 629 forwards the Authentication Response message 718 to the MME 624 as Authentication Response message 720.

After receiving an Authentication Response message 720, the MME 624 and UE 602B perform authentication 722 of the UE for access to the MNO core network 640B and grant the UE 602B access to the private 4G cellular network 620 based on the authentication with the MNO core network 640B. For example, the MME 624 sends an Authentication Request to the UE 602B, including the AUTH token. The UE 602B validates the AUTH token by comparing it to a token generated based on the secret key (Kᵢ). If the validation succeeds (e.g., the generated token matches or is substantially equal to the AUTH token), the UE 602B considers the network to be legitimate and sends an Authentication Response message back to the MME 624, including a RES token, which can also be generated based on the secret key (Kᵢ).

The MME 624 compares the RES token with the XRES token. If they match or are substantially equal, the MME 664 considers the UE 602B authenticated for access to the MNO core network 640B and grants the UE 602B access to the private 4G cellular network 620 based on the authentication. Once granted, data traffic from UE 602B can be routed to the PDN gateway (and ultimately to the internet or other external network), similar to the DN 225 of FIG. 2.

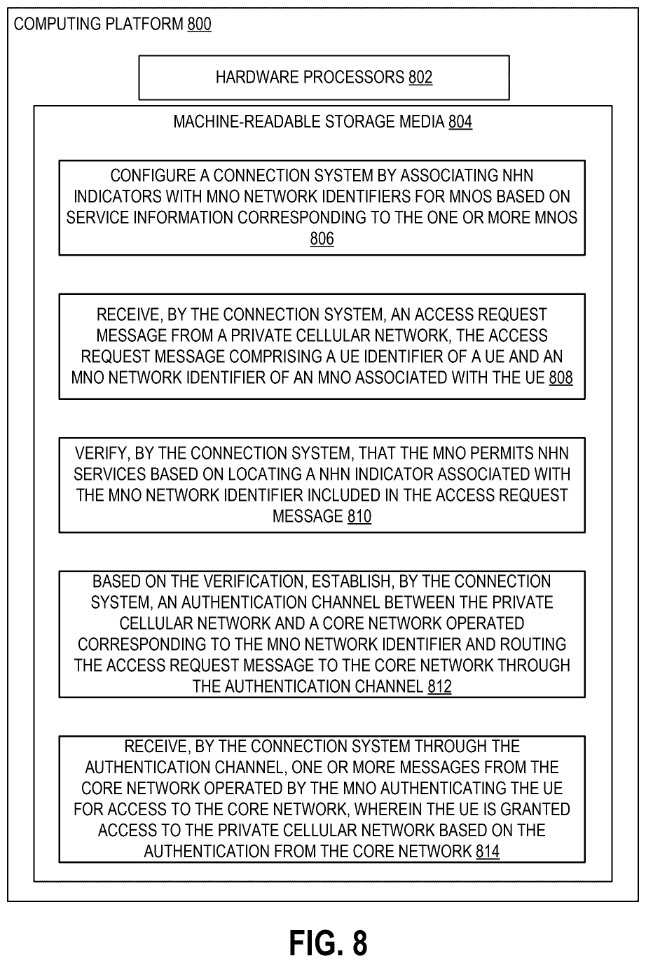

FIG. 8 illustrates a computing component that may be used to implement neutral host networks on private cellular networks in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium for 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-814, to control processes or operations disclosed herein. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-814.

Hardware processor 802 may execute instruction 806 to configure a connection system by associating NHN indicators with MNO network identifiers for one or more MNOs based on service information corresponding to the one or more MNOs. For example, as described above in connection with FIGS. 1 and 2, the connection system (e.g., one of NHN connection systems 130, 230, and/or 630) may receive one or more SLAs from the one or more MNOs, which include the service information defining NHN services offered by the one or more MNOs. The connection system may create one or more configuration files for the one or more MNOs that includes the NHN indicators based on the NHN services offered by the one or more MNOs. The connection system may be configured with the one or more configuration files, for example, by associating them with the MNO network identifiers of the one or more MNOs. In examples, the MNO network identifiers may include PLMN IDs.

Hardware processor 802 may execute instruction 808 to receive, by the connection system, an access request message from a private cellular network, the access request message comprising a UE identifier of a UE and an MNO network identifier of an MNO associated with the UE. In examples, the private cellular network may be a private 5G cellular network (e.g., private 5G cellular network 220), a private 4G cellular network (e.g., private 4G cellular network 620), a legacy cellular network, and/or a future cellular network. The access request message may be, for example, access request message 306, 406, 506, or Authentication Request message 706. The UE identifier, in examples, may be a Subscriber Identify Module (SIM) credentials, a Subscriber Concealed Identifier (SUCI), and/or an International Mobile subscriber identity (IMSI) of the UE. The access request message may be communicated according to RADIUS protocol, DIAMETER protocol, or SBI over TLS protocol using a RadSec interface, DIAMETER interface, or SBI, respectively.

In examples, the access request message may be based on a mobility function (e.g., an MME or AMF) of the private cellular network receiving an authentication request from the UE. For example, as described in connection with FIGS. 4, 5 and 7, the mobility function may receive an authentication request from the use as part of a registration 302, 402, 502 or an attach request message 702. Based on these messages, the mobility function may send an authentication request to other functions of the private cellular network, which ultimately converts the authentication request message to the access request message, as described above in connection with FIGS. 2-7.

Hardware processor 802 may execute instruction 810 to verify, by the connection system, that the MNO permits NHN services based on locating a NHN indicator associated with the MNO network identifier included in the access request message

Hardware processor 802 may execute instruction 812 to, based on the verification, establish, by the connection system, an authentication channel between the private cellular network and a core network corresponding to the MNO network identifier and routing the access request message to the core network through the authentication channel. For example, the connection system may extract the MNO network identifier from the access request message, locate a configuration file corresponding to the MNO using the network identifier, and determine that the configuration file includes an NHN indicator. If the connection system determines that the configuration file contains an NHN indicator, the connection system may establish an authentication channel between the private cellular network and the MNO core network specified by the MNO network identifier for the purpose of authenticating the UE based on the access request message received from the private cellular network. Alternatively, if a NHN indicator is not present, the connection system may send an error code back to the private cellular network.

Hardware processor 802 may execute instruction 812 to receive, by the connection system through the authentication channel, one or more messages from the core network operated by the MNO authenticating the UE for access to the core network. For example, the MNO core network may authenticate the UE using any authentication protocol known in the art, for example but not limited to, EAP-AKA′, 5G-AKA, and EPS-AKA, as described above in connection with FIGS. 3-5 and 7. Based on the desired authentication protocol, the MNO core network may send one or more message to the private cellular network to authenticate the UE at the private cellular network and permit access thereto, for example, as described in connection with FIGS. 3-5 and 7. Once authenticated by the MNO core network, the private cellular network may grant the UE access thereto using authentication credentials provisioned by the MNO core network.

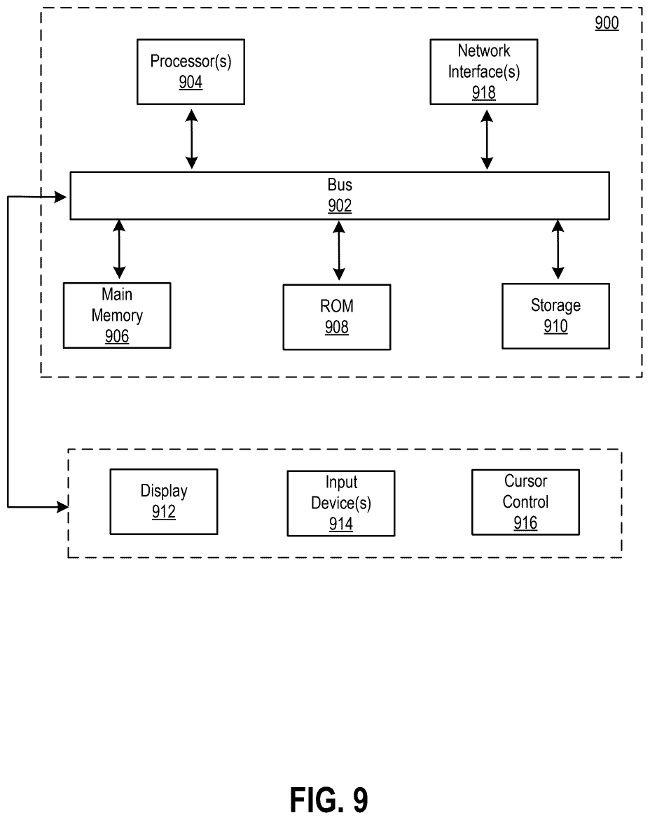

FIG. 9 depicts a block diagram of an example computer system 900 in which various examples of the disclosed technology described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors. The computer system 900 may be implemented as one or more component of the network configuration 100, communication system 200, and/or communication system 600 described in connection with FIGS. 1, 2, and 6.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions. For example, main memory 906 may store instructions, that when executed by processor(s) 904, cause computer system 900 to perform one or more of the operations described in connection with FIGS. 3-5, 7, and 8.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some examples, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one example of the disclosed technology, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a network interface 918 (also referred to as a communication interface) coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 918, which carry the digital data to and from computer system 900, are example forms of transmission media.

The computer system 900 can send messages and receive data, including program code, through the network(s), network link and network interface 918. In the Internet example, a server might transmit a requested code for an application program through the Internet, the ISP, the local network and the network interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
configuring a connection system by associating neutral host network (NHN) indicators with mobile network operator (MNO) network identifiers for one or more MNOs based on service information corresponding to the one or more MNOs;
receiving, by the connection system, an access request message from a private cellular network, the access request message comprising a user equipment (UE) identifier of a UE and an MNO network identifier of an MNO associated with the UE;
verifying, by the connection system, that the MNO permits NHN services based on locating a NHN indicator associated with the MNO network identifier included in the access request message;
based on the verification, establishing, by the connection system, an authentication channel between the private cellular network and a core network corresponding to the MNO network identifier and routing the access request message to the core network; and
receiving, by the connection system, one or more messages from the core network operated by the MNO authenticating the UE for access to the core network, wherein the UE is granted access to the private cellular network based on the authentication from the core network.

2. The method of claim 1, wherein the private cellular network comprises one or more of: a private 5G cellular network and a private 4G cellular network.

3. The method of claim 1, wherein configuring the connection system comprises:
receiving one or more service level agreements (SLAs) from the one or more MNOs, the one or more SLA agreements comprising the service information defining NHN services offered by the one or more MNOs;
creating one or more configuration files for the one or more MNOs that includes the NHN indicators based on the NHN services offered by the one or more MNOs; and
configuring the connection system with the one or more configuration files, wherein the one or more configuration files are associated with the MNO network identifiers of the one or more MNOs.

4. The method of claim 3, wherein verifying that the MNO permits NHN services comprises:
extracting, by the connection system, the MNO network identifier from the access request message;
locating a configuration file corresponding to the MNO using the network identifier; and
determining that the configuration file includes an NHN indicator.

5. The method of claim 1, wherein the MNO network identifier comprises a Public Land Mobile Network (PLMN) ID.

6. The method of claim 1, wherein the UE identifier comprises a Subscriber Identify Module (SIM) credentials, a Subscriber Concealed Identifier (SUCI), or an International Mobile subscriber identity (IMSI) of the UE.

7. The method of claim 1, wherein the access request message is communicated according to one of Remote Authentication Dial-In User Service (RADIUS) protocol, DIAMETER protocol, or Service Based Interface (SBI) over Transport Layer Security (TLS) protocol.

8. The method of claim 7, wherein the access request message is received over one of a RADIUS over TLS (RadSec) interface, a DIAMETER interface, or an SBI.

9. The method of claim 1, wherein the access request message is based on a mobility function of the private cellular network receiving an authentication request message from the UE.

10. The method of claim 1, wherein the one or more messages from the core network authenticating the UE for access is based on one of Extensible Authentication Protocol Authentication and Key Agreement (EAP-AKA′), 5G-AKA, or Evolved Packet System Authentication and Key Agreement (EPS-AKA).

11. A non-transitory computer-readable medium including instructions that, when executed by one or more processors, cause the one or more processors to:
configure a connection system by associating neutral host network (NHN) indicators with mobile network operator (MNO) network identifiers for one or more MNOs based on service information corresponding to the one or more MNOs;
receive, by the connection system, an access request message from a private cellular network, the access request message comprising a user equipment (UE) identifier of a UE and an MNO network identifier of an MNO associated with the UE;
verify, by the connection system, that the MNO permits NHN services based on locating a NHN indicator associated with the MNO network identifier included in the access request message;
based on the verification, establish, by the connection system, an authentication channel between the private cellular network and a core network corresponding to the MNO network identifier and routing the access request message to the core network through the authentication channel; and
receive, by the connection system through the authentication channel, one or more messages from the core network operated by the MNO authenticating the UE for access to the core network, wherein the UE is granted access to the private cellular network based on the authentication from the core network.

12. The non-transitory computer-readable medium of claim 11, wherein the private cellular network comprises one or more of: a private 5G cellular network and a private 4G cellular network.

13. The non-transitory computer-readable medium of claim 11, wherein the MNO network identifier comprises a Public Land Mobile Network (PLMN) ID.

14. The non-transitory computer-readable medium of claim 11, wherein the UE identifier comprises a Subscriber Identify Module (SIM) credentials, a Subscriber Concealed Identifier (SUCI), or an International Mobile subscriber identity (IMSI) of the UE.

15. The non-transitory computer-readable medium of claim 11, wherein the access request message is communicated according to one of Remote Authentication Dial-In User Service (RADIUS) protocol, DIAMETER protocol, or Service Based Interface (SBI) over Transport Layer Security (TLS) protocol.

16. The non-transitory computer-readable medium of claim 15, wherein the access request message is received over one of a RADIUS over TLS (RadSec) interface, a DIAMETER interface, or an SBI.

17. The non-transitory computer-readable medium of claim 11, wherein the access request message is based on a mobility function of the private cellular network receiving an authentication request message from the UE, wherein the mobility function is an Access and Mobility Management Function (AMF) or a Mobility Management Entity (MME).

18. The non-transitory computer-readable medium of claim 11, wherein the one or more messages from the core network authenticating the UE for access is based on one of Extensible Authentication Protocol Authentication and Key Agreement (EAP-AKA′), 5G-AKA, or Evolved Packet System Authentication and Key Agreement (EPS-AKA).

19. A system comprising:
a private cellular network that transmits an access request message based on a user equipment (UE) requesting access to the private cellular network, the access request message comprising a MNO network identifier of a mobile network operator (MNO) and a UE identifier;
a connection system that receives the access request message from the private cellular network, obtains the MNO network identifier from the access request message, and forwards the access request message to a core network operated by the MNO corresponding to the MNO network identifier; and
the core network that receives the access request from the connection system and authenticates the UE for access to the core network based the UE included in the access request; and
wherein the private cellular network grants the UE access to the private cellular network based on the authentication of the UE for access to the core network.

20. The system of claim 19, wherein the private cellular network comprises one or more of: a private 5G cellular network and a private 4G cellular network.
